(19) United States
(12) Patent Application Publication
(10) Pub. No.: US 2026/0227256 A1
(43) Pub. Date: Aug. 6, 2026

(54) TRANSDUCERS FOR VERIFYING TIGHTENING TOOLS BY MEASURING ONE OR MORE PARAMETERS OF JOINTS

(71) Applicant: ATLAS COPCO INDUSTRIAL TECHNIQUE AB, Stockholm (SE)

(72) Inventor: Francesco GIGLIOTTI, Tradate (VA) (IT)

(21) Appl. No.: 19/151,253

(22) PCT Filed: Jan. 24, 2024
(86) PCT No.: PCT/IB2024/050664

§ 371 Date: Jul. 25, 2025

(30) Foreign Application Priority Data
Jan. 26, 2023 (IT) 102023000001212

(51) Int. Cl. G01L 5/24

(52) U.S. Cl. CPC G01L 5/24

(57) ABSTRACT

Transducer for verifying a tightening tool may include an external casing having an opening for accessing an internal housing in the casing and a closure configured to close the opening. The closure may include a lid for closing the opening that is rotatably associated with the casing and movable between closing and opening positions relative to the opening. The closure includes a first locking portion and second locking portion associated with the lid. The first locking portion is configured to be moved between first locking and unlocking positions, and the second locking portion is configured to be moved between second locking and unlocking position. To move the lid from the closing position to the opening position, the second locking portion must be moved to the second unlocking position and maintained in the second unlocking position, and subsequently the first locking portion must be moved to the first unlocking position.

The present invention relates to a transducer, e.g. battery-operated, for verifying a tightening tool by measuring one or more parameters of a joint, such as the tightening torque and tightening angle.

The transducer according to the invention can either be a so-called “torque” rotary transducer, i.e. one that allows only the tightening torque to be measured, or a so-called “torque and angle” rotary transducer, i.e. one that, in addition to the tightening torque, also allows the tightening angle to be measured.

Nowadays, battery-operated transducers, both torque and torque-and-angle transducers, are known to be used when performing joint tightening operations.

These devices are positioned between the tightening tool and the joint to be tightened so as to allow measurement of the applied tightening torque, or of the tightening torque and angle; based on these measurements, the operator can verify the proper functioning of the tightening tool, the characteristics and parameters of the joint being known.

Battery-operated transducers of the known type can be used with various types of tightening tools, such as industrial electric or pneumatic screwdrivers, including tightening tools based on so-called “pulse” technology.

However, battery-operated transducers of the known type have certain drawbacks.

Tightening operations submit battery-operated transducers to very high dynamic stresses, especially when using tightening tools based on pulse technology.

In order to prevent the stresses generated during tightening operations from separating the battery from the transducer, in battery transducers of the known type the battery is integrated into the transducer body and cannot be removed therefrom; this means that removing the battery from the body of a known-type battery transducer requires the body itself to be disassembled.

Known-type (integrated) battery transducers have the problem that, once the battery charging capacity has expired, the device stops working and it is not possible to easily replace the out-of-power battery with a charged one.

In this case, unless additional charged back-up transducers are available, which involves a very expensive investment, the tightening operation must be temporarily interrupted to recharge the battery, lengthening the overall time required to complete this operation.

The present invention aims to obviate the aforementioned drawbacks by producing a battery-operated transducer in which the battery, housed in its own internal housing, can be replaced when out of power.

Within this object, another task of the present invention is to create a battery-operated transducer comprising a system for closing the battery internal housing so that does not open accidentally when performing tightening tests.

The task and objects of the present invention are achieved by a battery-operated transducer for testing a tightening device by measuring one or more parameters of a joint:
an external casing, comprising an internal housing suitable for housing a battery and accessible from a first opening obtained in the external casing;
a closure system of the first opening, comprising a lid, suitable for closing the first opening, rotatably associated with the external casing so that it can be moved between a closing position, in which it closes the first opening, and an open position, in which it allows access to the first opening from the outside of the transducer, wherein the closure system comprises:
   first locking means, associated with the lid, which, when the lid is positioned in the closing position, are at least partly accessible from the outside of the transducer so that they can be moved, selectively, from a first locking position, in which they prevent the movement of the lid from the closing position to the open position, to a first unlocking position, in which they allow such movement, and vice versa;
   second locking means, positioned between the lid and the first locking means, which, when the lid is in the closing position and the first locking means are in the first locking position, are at least partially accessible from the outside of the transducer so that they can be moved, selectively, from a second locking position, in which they prevent the movement of the first locking means from the first locking position to the first unlocking position, to a second unlocking position, in which they allow such movement,
wherein, to move the lid from the closing position to the open position, the second locking means must be moved to the second unlocking position, and maintained in the second unlocking position, and subsequently the first locking means must be moved to the first unlocking position.

Other advantageous features of the invention are reported in the dependent claims.

The features and advantages of the present invention will be more apparent from the following description, which is to be understood as exemplifying and not limiting, with reference to the appended schematic drawings, in which:

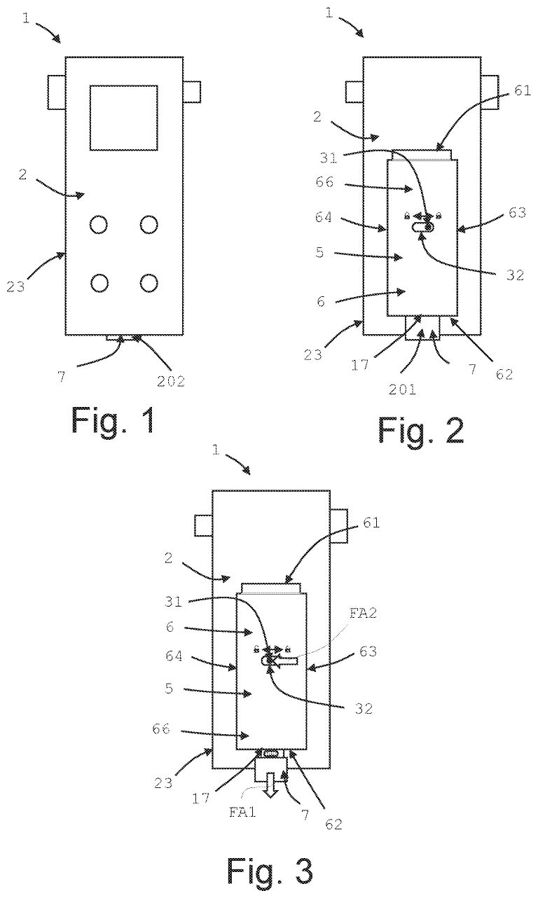

FIG. 1 is a plan view of the front side of the transducer according to the invention;

FIG. 2 is a plan view of the rear side of the transducer of FIG. 1 in which the lid is in the closing position, the first locking means are in the first locking position and the second locking means are in the second locking position;

FIG. 3 is a further plan view of the rear side of the transducer of FIG. 1 in which the lid is in the closing position, the first locking means are in the first unlocking position and the second locking means are in the second unlocking position;

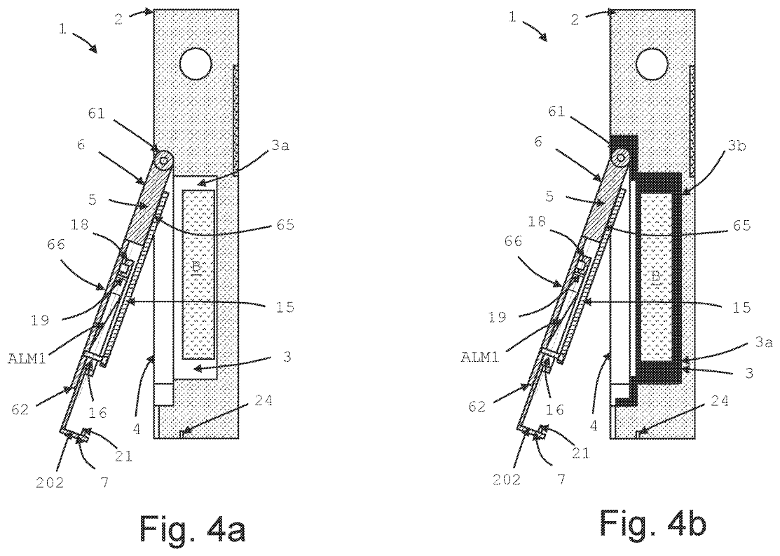

FIG. 4a is a side section view of the rotary transducer of FIG. 1 in which the lid, which is in the open position, is rotatably associated directly to the external casing, close to the internal housing;

FIG. 4b is a side section view of a further advantageous embodiment of a transducer according to the invention in which the lid, which is in the open position, is indirectly associated, rotatably, with the external casing by means of a separate element included in the transducer according to the invention, which is contained in the internal housing thereof;

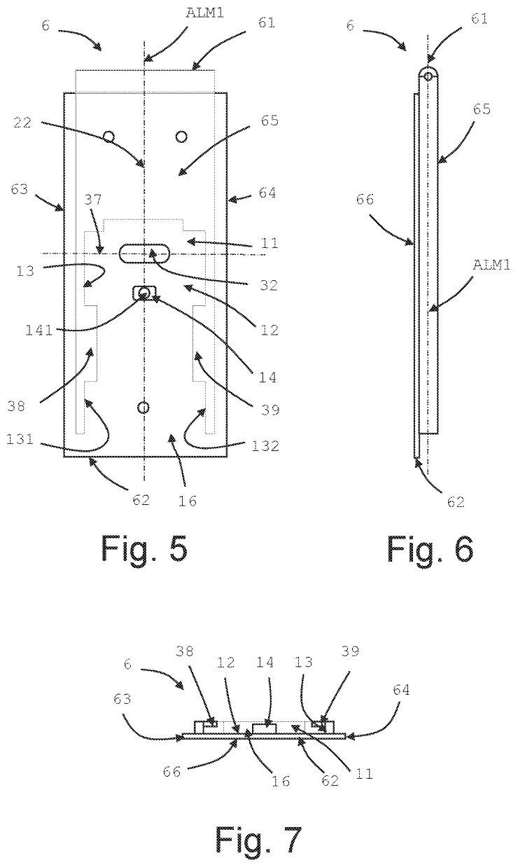

FIG. 5 is a plan view of the front side of the lid included in the closure system of the transducer of FIG. 1;

FIG. 6 is a side view of the lid of FIG. 5;

FIG. 7 is a view from below of the lid of FIG. 5;

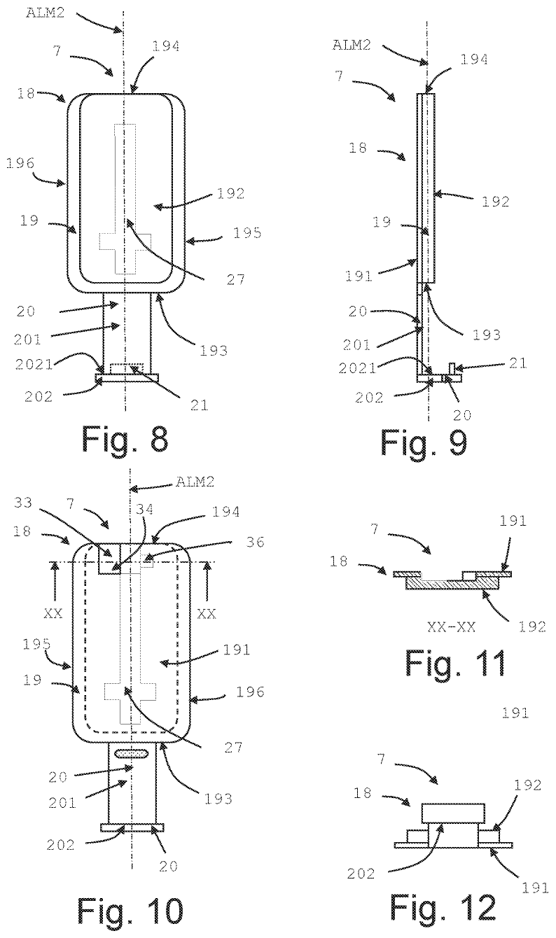

FIG. 8 is a plan view of the front side of a component included in the first locking means of the closure system of the transducer of FIG. 1;
FIG. 9 is a side view of the component of FIG. 8;

FIG. 10 is a plan view of the rear side of the element of FIG. 8;

FIG. 11 is a cross section view of the element of FIG. 8;

FIG. 12 is a view from below of the element of FIG. 8;

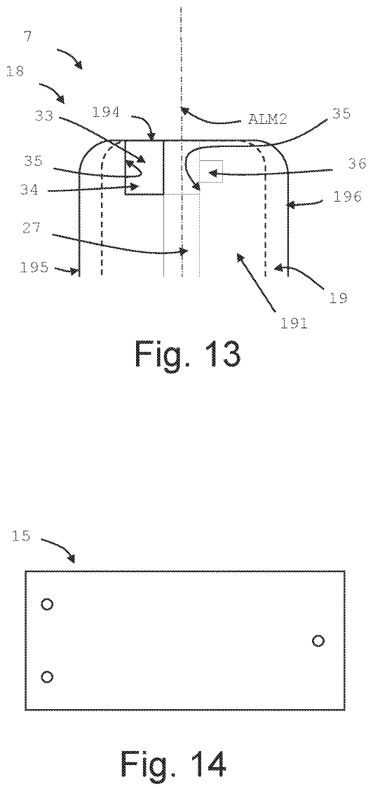

FIG. 13 is an enlargement of a portion of the element of FIG. 8, performed on the rear side thereof;

FIG. 14 is a plan view of a component of the closure system of the transducer of FIG. 1;

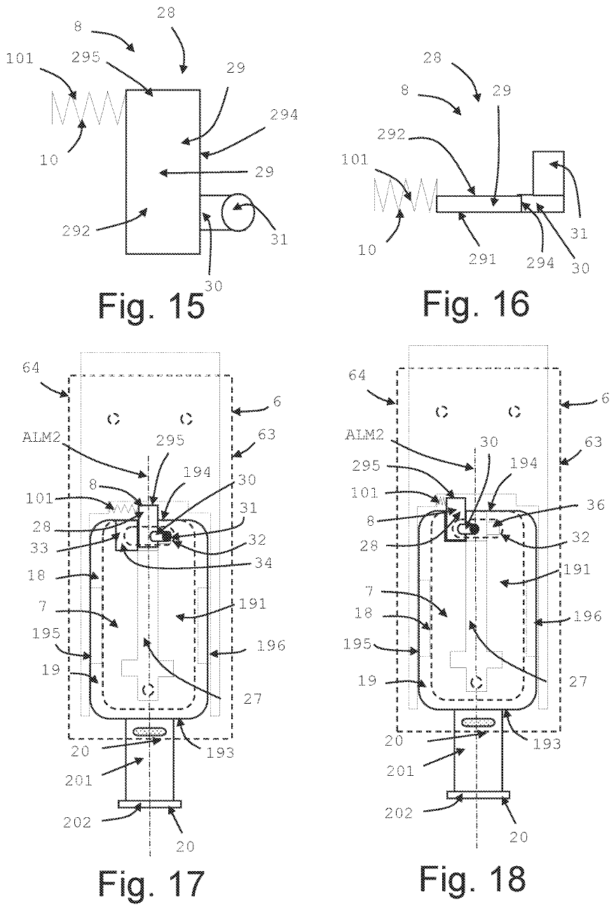

FIG. 15 is a plan view of an assembly comprising two further components of the closure system of the transducer of FIG. 1, one of which is included in the second locking means thereof;

FIG. 16 is a side view of the assembly of FIG. 15;

FIG. 17 is a plan view of the closure system of the transducer of FIG. 1 in which the lid is shown in transparency using dotted lines and the second locking means are in the second locking position;

FIG. 18 is a plan view of the closure system of the transducer of FIG. 1 in which the lid is shown in transparency using dotted lines and the second locking means are in the second unlocking position;

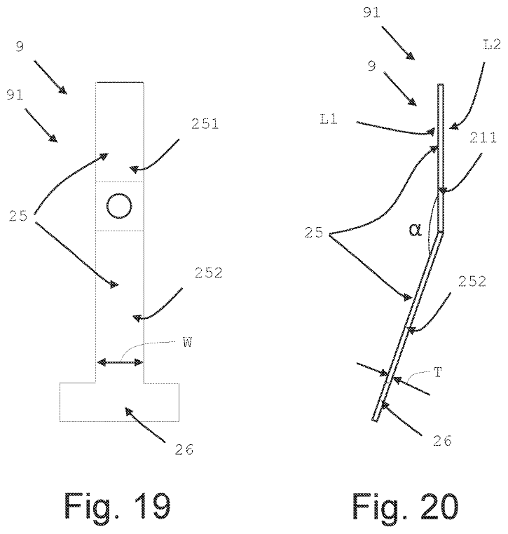

FIGS. 19 and 20 are, respectively, a plan view and a side view of a further component of the closure system of the transducer of FIG. 1;

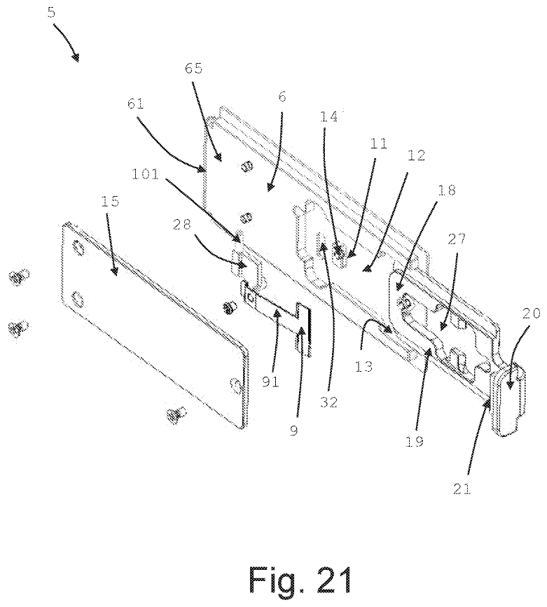

FIG. 21 is an exploded view of the closure system of the transducer of FIG. 1;

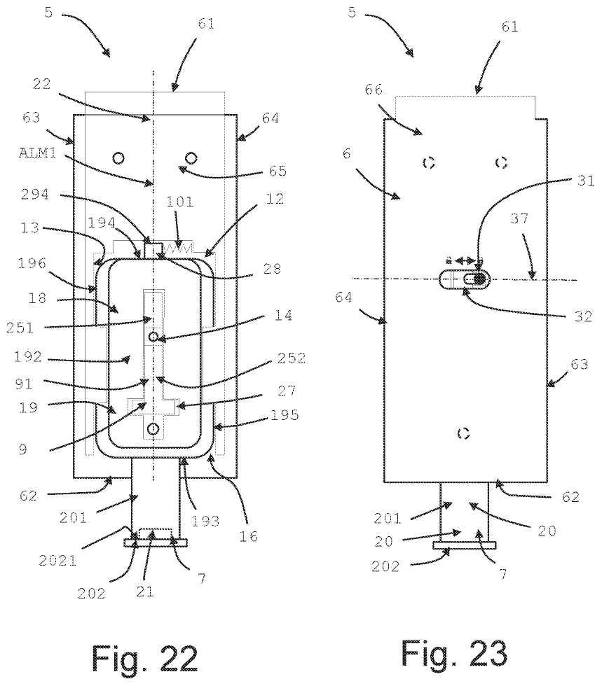

FIGS. 22 and 23 are two plan views, respectively, of the front side and rear side of the closure system of the transducer of FIG. 1, in which the first locking means and second locking means are in the first locking position and second locking positions, respectively;

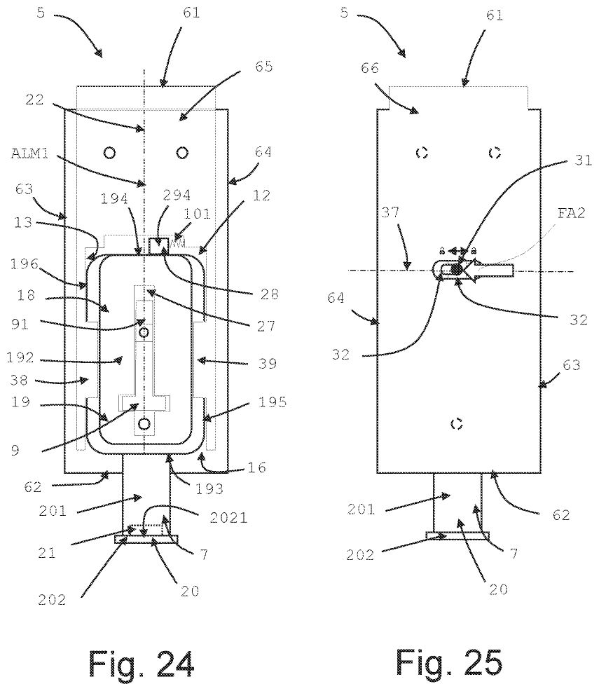

FIGS. 24 and 25 are two plan views, respectively, of the front side and rear side of the closure system of the transducer of FIG. 1, in which the first locking means and second locking means are in the first locking position and second unlocking position, respectively;

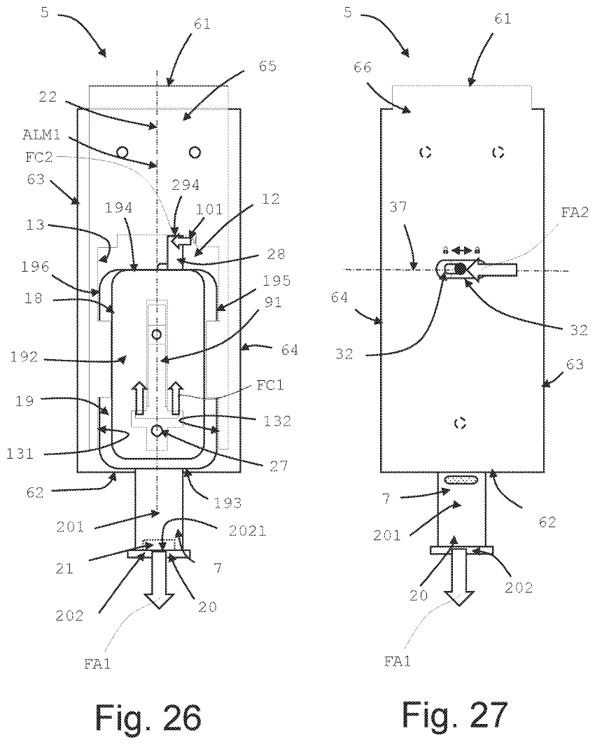

FIGS. 26 and 27 are two plan views, respectively, of the front side and rear side of the closure system of the transducer of FIG. 1, in which the first locking means and second locking means are in the first unlocking position and second unlocking positions, respectively;

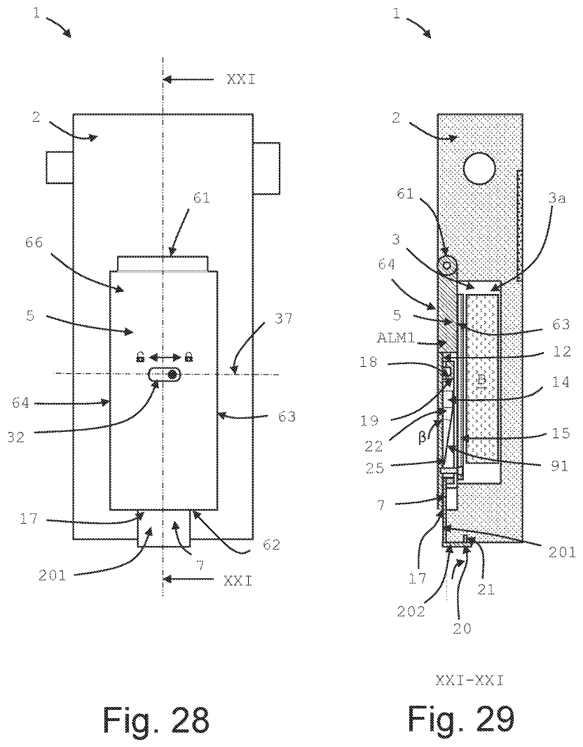

FIGS. 28 and 29 are, respectively, a plan view of the rear side of the transducer of FIG. 1 and a side section view of that transducer, in which the lid is in the closing position and the first locking means and second locking means are in the first locking position and second locking position, respectively;

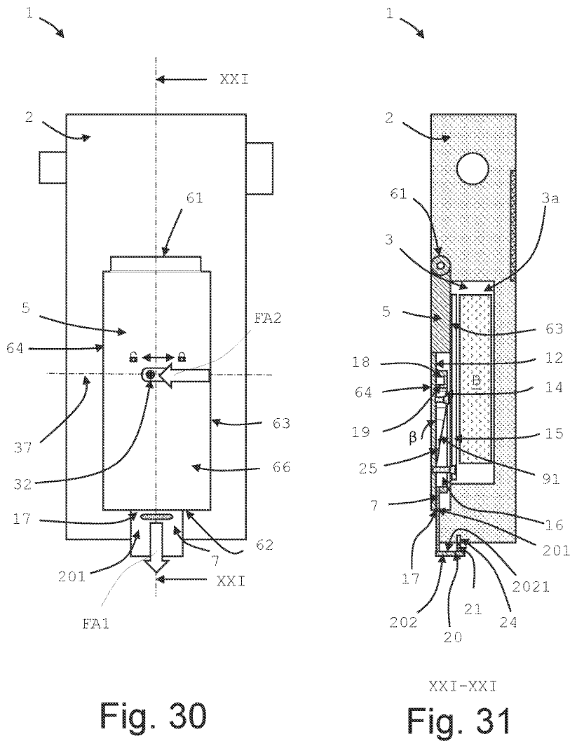

FIGS. 30 and 31 are, respectively, a plan view of the rear side of the transducer of FIG. 1 and a side section view of that transducer, in which the lid is in the closing position and the first locking means and second locking means are in the first unlocking position and second unlocking positions, respectively.

With reference to the enclosed Figures, a battery-operated transducer for verifying a tightening tool by measuring one or more parameters of a joint has been globally indicated by number 1.

In this text, “battery-operated transducer” means a transducer configured to be powered by a battery, preferably, but not necessarily, rechargeable.

The tightening parameters that can be measured with the transducer 1 according to the invention are, for example, the tightening torque and the tightening angle.

In the advantageous embodiment shown in FIGS. 4a, 4b, 29 and 31, by way of example, the transducer 1 according to the invention is represented with a battery therein, which is schematically represented with a rectangle and indicated by the letter B.

An advantageous embodiment of the transducer 1 according to the invention, such as the one shown in the enclosed Figures, allows both tightening torque and tightening angle to be measured.

Other advantageous embodiments of the transducer 1 according to the invention, not shown in the enclosed Figures, may be limited to measurement of the tightening torque.

The transducer 1 according to the invention comprises an external casing 2, comprising an internal housing 3, 3a suitable for housing a battery and accessible from a first opening 4 obtained in the external casing 2.

The transducer 1 according to the invention comprises a closure system 5 of the first opening 4, which comprises a lid 6 suitable for closing this first opening 4.

The lid 6 is rotatably associated with the external casing 2 so that it can be moved between a closing position, in which it closes the first opening 4 preventing access from the outside of the transducer 1, and an open position, in which it allows access to the first opening 4 from the outside of the transducer 1.

In this case, “allows access” means that in the open position the lid 6 allows a user to manually insert a battery, e.g. a rechargeable battery, into the internal housing 3, 3a through the first opening 4.

In an advantageous embodiment of the transducer 1 according to the invention, such as the one shown in FIGS. 1 to 3, 4a, 28, 29, 30 and 31, the lid 6 is rotatably associated with the external casing 2 near the internal housing 3, 3a, preferably at the same.

In such an advantageous embodiment, the lid 6 is preferably hinged to the external casing 2.

In other advantageous embodiments of the transducer 1 according to the invention, the lid 6 is rotatably associated with the external casing 2 indirectly, i.e. via one or more elements included in the transducer 1, distinct from the external casing 2 and associated with the latter.

In one of such advantageous embodiments, such as the one shown in FIG. 4b, the transducer 1 comprises an insert 3b suitable for housing a battery.

Always in such an advantageous embodiment, the internal housing 3, 3a is also suitable for housing the insert 3b; the insert 3b is advantageously associated with the external casing 2, within the internal housing 3, 3a, and the lid 6 is rotatably associated with the external casing 2 preferably by means of the insert 3b.

Again, in this advantageous embodiment, the lid 6 can be, for example, hinged to the insert 3b.

Advantageously, the insert 3b is shaped like an open box and is positioned inside the internal housing 3, 3a of the transducer 1 so that it is possible to manually insert a battery therein when the lid 6 is in the open position.

Advantageously, the insert 3b can be associated with the external casing 2 by means of one or more screws, not shown, or by gluing.

Advantageously, the insert 3b comprises a metal material, such as aluminium or steel.

In an advantageous embodiment of the transducer 1 according to the invention, such as the one shown in the enclosed Figures, the lid 6 is shaped as a plate having, in plan, a preferably rectangular geometry.

Advantageously, the lid 6 comprises a first transverse end 61, near which it is associated with the external casing 2, and a second transverse end 62, opposite the first transverse end 61; the lid 6 further comprises a first longitudinal end 63 and an opposite second longitudinal end 64.

Advantageously, still in this embodiment, the lid 6 comprises a first face 65, preferably plane, facing the transducer 1 when the lid 6 is in the closing position, and an opposite second face 66, preferably plane and parallel to the first face 65, facing the outside of the transducer 1 when the lid 6 is in the closing position.

Advantageously, the lid 6 comprises a first seat 11 obtained on the first face 65.

Advantageously, the first seat 11 has an elongated shape and is delimited at the bottom by a first support surface 12, preferably plane and preferably parallel to the first face 65 of the lid 6, and, at the sides, by a first internal side surface 13.

In an advantageous embodiment of the transducer 1 according to the invention, such as, for example, the one shown in the enclosed Figures, the first internal side surface 13 of the first seat 11 comprises a first surface portion 131 and a second surface portion 132 each facing inwardly of the first seat 11 and arranged parallel to a first longitudinal mean axis ALM1 of the first seat 11 and perpendicular to the first support surface 12 of the first seat 11.

Advantageously, a first constraining element 38 and a second constraining element 39 protrude from the first surface portion 131 and second surface portion 132, respectively.

Advantageously, the first constraining element 38 and the second constraining element 39 are both shaped like a foil and extend with their distal end towards the centre of the first seat 11, perpendicularly to the first surface portion 131 and to the second surface portion 132, respectively.

Advantageously, the two constraining elements 38 and 39 face the first support surface 12 with one face thereof parallel to that surface 12 and spaced from that surface 12.

Advantageously, the lid 6 comprises a fastener 14 protruding from the first support surface 12 of the first seat 11, preferably perpendicularly thereto; the fastener 14 comprises a threaded hole 141 preferably positioned, in plan, so as to be aligned with the first longitudinal mean axis ALM1 of the first seat 11.

Advantageously, the transducer 1 comprises a closing element 15, shaped as a plane foil having, in plan, a preferably rectangular geometry.

Advantageously, the closing element 15 is fixed to the lid 6, preferably in contact with the first face 65 thereof, so that the first seat 11 is closed at that face 65; the closing element 15 is preferably fixed to the lid 6 by means of screws.

In one advantageous embodiment of the transducer 1 according to the invention, such as the one shown in the enclosed Figures, the first seat 11 is open at the sides in the direction of the second transverse end 62 of the lid 6, at a second opening 16 defined, at least partially, by the first support surface 12 and the first internal side surface 13, as well as by the closing element 15 which closes the first seat 11.

Advantageously, when the lid 6 is in the closing position, it defines, with a portion of the external casing 2, a third opening 17 facing the second opening 16 of the first seat 11, which is suitable for putting this second opening 16 into communication with the outside of the transducer 1.

The closure system 5 of the transducer 1 according to the invention comprises first locking means 7, associated with the lid 6, which, when the lid 6 is in the closing position, are at least partially accessible from the outside of the transducer 1 SO they can be moved, selectively, from a first locking position, in which they prevent the movement of the lid 6 from the closing position to the open position, to a first unlocking position, in which they allow such movement.

In this case, “accessible from the outside” means that, when the lid 6 is positioned in the closing position, the first locking means 7 protrude, at least partially, outwards from the transducer 1, so that a user can move them from the first locking position to the first unlocking position, and vice versa, by exerting a force, e.g. a pushing force, thereon directly with their fingers.

Advantageously, the first locking means 7 can be moved from the first locking position to the first unlocking position, and vice versa, along a first straight sliding direction 22.

In an advantageous embodiment of the transducer 1 according to the invention, such as the one shown in the enclosed Figures, the first locking means 7 comprise a first slider 18.

Advantageously, the first slider 18 comprises a first portion 19, shaped as a plate having, in plan, a preferably substantially rectangular geometry.

Advantageously, the first portion 19 comprises a third face 191, preferably plane, and a fourth face 192, preferably plane, opposite and preferably parallel to the third face 191; the first portion 19 further comprises a third transverse end 193 and a fourth transverse end 194 opposite to each other and perpendicular to a second longitudinal mean axis ALM2 of the first portion 19, and a third longitudinal end 195 and a fourth longitudinal end 196, opposite to each other and parallel to the axis ALM2.

Advantageously, the first slider 18 comprises a second portion 20 which preferably forms a single body with the first portion 19.

Advantageously, the second portion 20 protrudes from the third transverse end 193 of the first portion 19, perpendicular to that end 193 with a first tract 201 thereof.

Advantageously, the second portion 20 comprises a second tract 202 which forms a single body with the first tract 201 and protrudes from the latter, perpendicular thereto, so as to form an L; the second tract 202 extends in the direction exiting the fourth face 192 of the first portion 19.

Advantageously, the second tract 202 comprises a fifth face 2021 facing the first portion 19 and preferably perpendicular to the first tract 201; from the fifth face 2021 protrudes a third portion 21 of the first slider 18 preferably having an elongated shape along a direction parallel to the second longitudinal mean axis ALM2 of the first portion 19, and a preferably rectangular cross-section.

Advantageously, the first seat 11 is suitable for housing the first slider 18 so that it can be moved along the first sliding direction 22; the first sliding direction 22 is preferably parallel to the first longitudinal mean axis ALM1 of the first seat 11.

Advantageously, the first slider 18 is slidably housed in the first seat 11 with its first portion 19, so that the second longitudinal mean axis ALM2 thereof is parallel to the first longitudinal mean axis ALM1 of the first seat 11.

Advantageously, the first portion 19 of the first slider 18 is at least partially positioned between the first and second constraining elements, 38 and 39, and the first support surface 12 of the first seat 11; the first and second constraining elements, 38 and 39, hinder the movement of the first portion 19 of the first slider 18, and thus of the first slider 18, away from the first support surface 12 along a direction perpendicular to the latter.

The third face 191 of the first portion 19 faces the first support surface 12 of the first seat 11 and the third transverse end 193 faces the second transverse end 62 of the lid 6; the third longitudinal end 195 of the first portion 19 faces the second longitudinal end 64 of the lid 6, and the fourth longitudinal end 196 faces instead the first longitudinal end 63 of the lid 6.

Advantageously, the external casing 2 of the transducer 1 comprises a side wall 23 on which a second seat 24 is obtained; the second seat 24 is in fluid communication with the outside of the transducer 1 and has an elongated shape along a first insertion direction parallel to the first sliding direction 22, when the lid 6 is in the closing position.

Advantageously, the second portion 20 of the first slider 18 passes through the second opening 16 and, when the lid 6 is in the closing position, it protrudes out of the transducer 1 through the third opening 17.

In particular, when the lid 6 is in the closing position, the first tract 201 of the second portion 20 is slidably housed into the third opening 17, so that it can move through it along the first sliding direction 22.

Advantageously, when the lid 6 is in the closing position, the second tract 202 of the second portion 20 faces, with the fifth face 2021, the side wall 23 of the external casing 2.

Advantageously, when the lid 6 is in the closing position, the third portion 21 of the first slider 18 faces with its distal end the second seat 24 and is aligned with it along the first insertion direction.

Advantageously, the second seat 24 is shaped so that it can slidably house the third portion 21 of the first slider 18 so that it can be moved therein along the first insertion direction.

In an advantageous embodiment of the transducer 1 according to the invention, such as for example the one shown in the enclosed Figures, when the lid 6 is in the closing position, the first slider 18 can be positioned in a first locking position, in which the third portion 21 is at least partially housed within the second seat 24, hindering the movement of the lid 6 from the closing position to the open position, and in a first unlocking position, in which the third portion 21 is positioned completely outside of the second seat 24, with its distal end spaced apart from the side wall 23 so as to allow the movement of the lid 6 from the closing position to the open position.

In an advantageous embodiment of the transducer 1 according to the invention, such as the one shown in the enclosed Figures, the locking system 5 comprises first elastic means 9 configured to exert a first closing force FC1 on the first locking means 7 suitable for moving them from the first unlocking position to the first locking position, when they are in the first unlocking position.

Advantageously, the first elastic means 9 comprised a flat spring.

A “flat spring” is defined as a spring with a strip-like shape, i.e. flat and elongated, made, for example, of steel and suitably shaped; such springs have a width W which can vary, for example, from 5 to 70 mm, and a maximum thickness T which can be, for example, 2.5 mm.

In advantageous embodiments of the transducer 1, not shown in the enclosed Figures, the first elastic means 9 may comprise a compression-type spring or a tension-type spring.

In an advantageous embodiment of the transducer 1, such as the one shown in the enclosed Figures, the first elastic means 9 comprise a first spring 91 of the flat type.

Advantageously, the first spring 91 comprises a fourth portion 25 with a strip-like shape; the fourth portion 25 comprising a third tract 251 and a fourth tract 252, which are contiguous and preferably inclined to each other on a first side L1 of the first spring 91, to form a preferably obtuse angle α.

Advantageously, the first spring 91 comprises a fifth portion 26, with a strip-like shape, forming a single body with the fourth portion 25 at one end of the fourth tract 252; the fifth portion 26 is arranged perpendicular to the fourth tract 252 so as to form a T with it.

Advantageously, the first spring 91 is fixed via its third tract 251 to the fastener 14 of the lid 6, preferably with its first side L1 facing the first support surface 12 of the first seat 11; the first spring 91 is fixed to the fastener 14 preferably with a screw.

Advantageously, when the first spring 91 is fixed to the fastener 14, the third tract 251 of its fourth portion 25 is arranged parallel to the first support surface 12 of the first seat 11, and the fourth tract 252 of the fourth portion 25 is directed towards the second transverse end 62 of the lid 6, inclined towards the first support surface 12 of the first seat 11.

Advantageously, the fifth portion 26 of the first spring 91 is in contact with the first support surface 12 of the first seat 11 and forms with it an acute angle β facing the first transverse end 61 of the lid 6.

Advantageously, the first portion 19 comprises a fourth, through opening 27, shaped in such a way that, when the first slider 18 is positioned in the first locking position, the first spring 91 is, in plan view, entirely facing the closing element 15 and in such a way that, when the first slider 18 is positioned in the first unlocking position, the first portion 19 of the first slider 18 is interposed between the fifth portion 26 of the first spring 91 and the closing element 15.

Advantageously, when the first slider 18 is positioned in the first locking position, the fifth portion 26 is at least partially inserted into the fourth opening 27, protruding from it in the direction of the closing element 15.

Advantageously, when the first slider 18 is in the first unlocking position, and the first portion 19 of the first slider 18 is interposed between the fifth portion 26 and the closing element 15, the first portion 19 is in contact with the fifth portion 26 and maintains it in a condition of elastic deformation by pushing it towards the first support surface 12, thereby reducing the angle β that the fifth portion 26 forms with that surface 12.

When the first slider 18 is in the first unlocking position, the first spring 91 is thus in a condition of elastic deformation and exerts a springback force on the first slider 18; the first closing force FC1 is the springback force exerted by the first spring 91 on the first slider 18 as a result of the elastic deformation.

In an advantageous embodiment of the transducer 1 according to the invention, such as the one shown in the enclosed Figures, the first closing force FC1 has a component acting along a line of action parallel to the first sliding direction 22 and oriented from the second transverse end 62 to the first transverse end 61 of the lid 6.

The closure system 5 of the transducer 1 according to the invention comprises second locking means 8, positioned between the lid 6 and the first locking means 7, which, when the lid 6 is positioned in the closing position and the first locking means 7 are in the first locking position, are at least partially accessible from the outside of the transducer 1 so that they can be moved, selectively, from a second locking position, in which they prevent the movement of the first locking means 7 from the first locking position to the first unlocking position, to a second unlocking position, in which they allow such movement.

In this case, “accessible from the outside” means that such second locking means 8 at least partially protrude outwards from the transducer 1 according to the invention, when the lid 6 is in the closing position, so that, when the first locking means 7 are in the first locking position, an operator can move them from the second locking position to the second unlocking position by exerting a force thereon, e.g. pushing, directly with their fingers.

Advantageously, the second locking means 8 can be moved from the second locking position to the second unlocking position, and vice versa, along a second straight sliding direction 37.

In one advantageous embodiment of the transducer 1 according to the invention, such as the one shown in the enclosed Figures, the first sliding direction 22 and the second sliding direction 37 are perpendicular to each other.

Advantageously, also in this embodiment, the second locking means 8 comprise a second slider 28.

Advantageously, the second slider 28 comprises a sixth portion 29 shaped as a foil having, in plan, a preferably rectangular geometry; the sixth portion 29 comprises a sixth face 291, preferably plane, a seventh face 292, preferably plane, opposite and preferably parallel to the sixth face 291.

Advantageously, still in this embodiment, the second slider 28 comprises a seventh portion 30, having an elongated shape, projecting from a fifth longitudinal end 294 of the sixth portion 29, perpendicular thereto.

Advantageously, still in this embodiment, the second slider 28 comprises an eighth portion 31.

In one advantageous embodiment of the transducer 1 according to the invention, such as the one shown in the enclosed Figures, the eighth portion 31 protrudes from the seventh portion 30 perpendicularly to the seventh face 292 of the sixth portion 29, in the direction exiting that face 292.

In alternative advantageous embodiments, not shown, the eighth portion 31 protrudes directly from the seventh face 292, perpendicular thereto.

Advantageously, the eighth portion 31 has a circular cross-section so that it is shaped as a cylindrical pivot.

In one advantageous embodiment of the transducer 1 according to the invention, e.g. as shown in the enclosed Figures, the lid 6 comprises a fifth, through opening 32, obtained on the first support surface 12 of the first seat 11.

Advantageously, the fifth opening 32 is shaped as an elongated slot along a direction parallel to the second sliding direction 37 and thus perpendicular to the first sliding direction 22.

In one advantageous embodiment of the transducer 1 according to the invention, such as the one shown in the enclosed Figures, the first slider 18 comprises a third seat 33.

Advantageously, the third seat 33 is obtained on the third face 191 of the first portion 19 of the second slider 18; the third seat 33 is delimited at the bottom by a second support surface 34 and, at the sides, by a second internal side surface 35.

Advantageously, the third seat 33 is positioned at the fourth transverse end 194 of the first portion 19 of the first slider 18 and is preferably open at the sides at the fourth transverse end 194.

Advantageously, the third seat 33 is suitable for housing the second slider 28 so that it can move therein both along a direction parallel to the second longitudinal mean axis ALM2 and along a direction perpendicular to the second longitudinal mean axis ALM2 of the first portion 19 of the first slider 18.

Advantageously, still in this embodiment, the first slider 18 comprises a fourth seat 36.

Advantageously, the fourth seat 36 consists of a recess of the second internal side surface 35 of the third seat 33, which is elongated in shape and extends along a second insertion direction perpendicular to the second longitudinal mean axis ALM2 of the first portion 19 and parallel to the second support surface 34 of the third seat 33; the third seat 33 and the fourth seat 36 are in communication along the second insertion direction.

In one advantageous embodiment, the fourth seat 36 extends from the third seat 33 in the direction of the fourth longitudinal end 196 of the first portion 19 of the first slider 18.

Advantageously, the fourth seat 36 is suitable for housing the seventh portion 30 of the second slider 28 so as to allow its movement along the second insertion direction, and hinder its movement along a direction parallel to the second longitudinal mean axis ALM2 of the first portion 19.

In one advantageous embodiment of the transducer 1 according to the invention, for example like the one shown in the enclosed Figures, the second slider 28 is positioned within the closing system 5 so that, when the first slider 18 is positioned in the first locking position, its sixth portion 29 is positioned between the first portion 19 of the first slider 18 and the lid 6; the sixth face 291 of the sixth portion 29 faces the first portion 19, preferably facing the third seat 33 obtained thereon, and the seventh face 292 faces the lid 6, preferably facing the second support surface 12 of the first seat 11.

Advantageously, the eighth portion 31 of the second slider 28 is inserted into the fifth opening 32 obtained on the first support surface 12 of the first seat 11, protruding from the second face 66 of the lid 6, preferably perpendicularly thereto; when the lid 6 is in the closing position the distal end of the eighth portion 31 is thus accessible from the outside of the transducer 1.

“Accessible from the outside” means that a user can exert a force, e.g. pushing, directly with their fingers on the distal end of the eighth portion 31 even when the lid 6 is in the closing position.

Advantageously, the fifth opening 32 is shaped so that it allows the movement of the second slider 28 along a direction parallel to the second sliding direction 37 and hinders the movement of the second slider 28 along a direction parallel to the first sliding direction 22, when the eighth portion 31 is inserted therein.

Advantageously, also in this embodiment, the second slider 28 is housed, with its sixth portion 29, in the third seat 33 obtained on the first portion 19, so that the seventh portion 30 is oriented in the direction of the fourth longitudinal end 196 of the first portion 19 and is arranged perpendicularly to the second longitudinal mean axis ALM2 of that portion 19.

In one advantageous embodiment of the transducer 1 according to the invention, such as for example the one shown in the enclosed Figures, when the first slider 18 is in the first locking position, the second slider 28 may be positioned in a second locking position, in which the seventh portion 30 thereof is housed within the fourth seat 36 of the first slider 18, thereby hindering the movement of the same slider 18 from the first locking position to the first unlocking position along the first sliding direction 22; the second slider 28 is shown as positioned in the second locking position in FIGS. 2, 17, 22, 23 and 28.

Advantageously, still in the same embodiment, when the first slider 18 is in the first locking position, the second slider 28 can be positioned in a second unlocking position, wherein the seventh portion 30 is positioned outside the fourth seat 36 so that the first slider 18 can be moved from the first locking position to the first unlocking position; the second slider 28 is represented positioned in the second unlocking position in FIGS. 3, 18, 24, 25 and 30.

Advantageously, when the lid 6 is in the closing position, the first slider 18 is in the first locking position, and the second slider 28 is in the second unlocking position, the seventh portion 30 of the second slider 28 is housed in the third seat 33 and facing the fourth seat 36; the seventh portion 30 and the fourth seat 36 are aligned along the second insertion direction, which in this case is aligned with the second sliding direction 37, and the movement of the second slider 28 from the second unlocking position to the second locking position along said direction 37 is allowed.

Advantageously, when the lid 6 is in the closing position, the first slider 18 is in the first unlocking position, and the second slider 28 is in the second unlocking position, the seventh portion 30 of the second slider 28 is housed in the third seat 33 and facing the second internal side surface 35 thereof; the seventh portion 30 and the fourth seat 36 are not aligned along a direction parallel to the second sliding direction 37 and therefore the movement of the second slider 28 from the second unlocking position to the second locking position is not permitted.

In one advantageous embodiment of the transducer 1 according to the invention, such as the one shown in the enclosed Figures, the locking system 5 comprises second elastic means 10 configured to exert a second closing force on the second locking means 8, suitable for moving them from the second unlocking position to the second locking position, when they are in the second unlocking position.

Advantageously, the second elastic means 10 comprise a compression spring.

In one advantageous embodiment of the transducer 1, such as the one shown in the enclosed Figures, the second elastic means 10 comprise a second compression spring 101.

Advantageously, in such embodiment, when the first slider 18 is in the first unlocking position, in plan view, the sixth portion 29 of the second slider 28 protrudes with one of its fifth transverse ends 295 from the fourth transverse end 194 of the first portion 19 of the first slider 18, facing the first internal side surface 13 of the first seat 11 along a direction parallel to the second sliding direction 37.

Advantageously, the second spring 101 is positioned between the fifth transverse end 295 of the sixth portion 29 and the second longitudinal end 64 of the lid 6, in contact with that fifth transverse end 295 and with the first internal side surface 13 of the first seat 11.

Advantageously, when the second slider 28 is moved towards the second unlocking position, the second spring 101 is compressed, exerting an elastic return force on the second slider 28; the second closing force FC2 is the elastic return force exerted by the second spring 101 on the second slider 28.

In one advantageous embodiment of the transducer 1 according to the invention, such as the one shown in the enclosed Figures, the second closing force FC2 has a component acting along a line of action parallel to the second sliding direction 37 and oriented from the second longitudinal end 64 to the first longitudinal end 63 of the lid 6.

Advantageously, even when the second slider 28 is positioned in the second locking position the second spring 101 is in a compressed state; thus, even in this condition the second spring 101 exerts the second locking force FC2 on the second slider 28 preventing it from accidentally moving towards the second unlocking position.

The following describes the operation of the transducer 1 according to the invention.

In one advantageous embodiment of the transducer 1 according to the invention, such as the one shown in the enclosed Figures, the first elastic means 9 hinder the movement of the first locking means 7 towards the first unlocking position, and the second elastic means 10 hinder the movement of the second locking means 8 towards the second unlocking position so that, when the lid 6 is in the closing position, accidental movement of the lid 6 itself towards the open position is not possible.

To move the lid 6 from the closing position to the open position, the second locking means 8 must be brought into the second unlocking position and held in that position, and then the first locking means 7 must be brought into the first unlocking position and held in that position during the movement of the lid 6 from the closing position to the open position.

In one advantageous embodiment of the transducer 1 according to the invention, such as the one shown in the enclosed Figures, in order to move the second closing means 8 from the second locking position to the second unlocking position, it is necessary to move the second slider 28 along the second sliding direction 37, from the second locking position to the second unlocking position, by exerting thereon a second opening force FA2 having a component acting along a line of action parallel to the second sliding direction 37 and directed from the second locking position to the second unlocking position.

In one advantageous embodiment, such as the one shown in the enclosed Figures, the component of the second opening force FA2 is directed from the first longitudinal end 63 to the second longitudinal end 64 of the lid 6.

When the second slider 28 is positioned in the second unlocking position and the first slider 18 is positioned in the first locking position, the seventh portion 30 of the second slider 28 and the fourth seat 36 of the first slider 18 are aligned along the second sliding direction 37; by releasing the second opening force FA2, the second closing force FC2, exerted by the second spring 101 on the second slider 28, would return the second slider 28 to the second locking position, preventing the subsequent movement of the first slider 18 from the first locking position to the first unlocking position.

To prevent the second closing force FC2 from returning the second slider 28 to the second locking position, the application of the second opening force FA2 must be maintained on the second slider 28; the second slider 28 must then be maintained in the second unlocking position to then move the first slider 18 from the first locking position to the first unlocking position.

Subsequently, still in this advantageous embodiment, in order to move the first locking means 7 from the first locking position to the first unlocking position, the first slider 18 must be moved along the first sliding direction 22, from the first locking position to the first unlocking position by exerting thereon a first opening force FA1 having an acting component along a line of action parallel to the first sliding direction 22 and directed from the first locking position to the first unlocking position.

In one advantageous embodiment, such as the one shown in the enclosed Figures, the component of the first opening force FA1 is directed from the first transverse end 61 to the second transverse end 62 of the lid 6.

When the first slider 18 is in the first unlocking position and the lid 6 is in the closing position, the third portion 21 of the first slider 18 is aligned with the second seat 24 along the first insertion direction; by releasing the first opening force FAI, the first closing force FC1, exerted by the first spring 91 on the first slider 18, would return the latter to the first locking position, preventing the movement of the lid 6 towards the open position.

In order to prevent the first closing force FC1, exerted by the first spring 91 on the first slider 18, from moving the latter from the first unlocking position to the first locking position, before having moved the lid 6 from the closing position to the open position, it is necessary to maintain the application of the first opening force FA1 on the first slider 18 and simultaneously move the lid 6 to the open position.

In summary, when the lid 6 of the transducer 1 is in the closing position, in order to bring it into the open position an operator must:
apply a second opening force FA2 on the second slider 28 moving it from the second locking position to the second unlocking position;
apply a first opening force FAI on the first slider 18, moving it from the first locking position to the first unlocking position while maintaining the application of the second opening force FA2 on the second slider 28;
when the first slider 18 is in the first unlocking position, FA2 can be released on the second slider 28 and the lid 6 can be rotated from the closing position to the open position.

It was thus found that the battery-operated transducer according to the invention solves the above-mentioned task and purposes.

In fact, the transducer according to the invention allows the battery to be replaced, for example when out of power, by means of an appropriate closure system that allows to selectively open and close the first opening of the internal housing in which the battery is contained.

In addition, the closure system of the transducer according to the invention prevents the first opening of the internal housing from accidentally opening, thus preventing the unwanted removal of the battery from such housing when performing a tightening operation.

In fact, when the lid is in the closing position and the first slider and second slider are in their respective locking positions, the movement of the lid towards the open position is only possible if the second slider is moved towards the respective unlocking position, and held there and then the first slider is also moved to the respective unlocking position. The first spring and the second spring push, respectively, the first slider and the second slider to their respective locking positions in order to prevent them from being accidentally moved towards their respective unlocking positions due to the stresses generated while performing a tightening operation.

Finally, it is clear that the battery-operated transducer according to the invention is susceptible to numerous modifications or variations, all of which are within the scope of the invention; moreover, all of the details are replaceable by technically equivalent elements without departing from the scope of the appended claims.

1. A battery-operated transducer for verifying a tightening tool by measuring one or more parameters of a joint, comprising:
an external casing comprising an internal housing configured to house a battery and accessible from a first opening obtained in said external casing;
a closure system of said first opening comprising a lid configured to close said first opening and rotatably associated with said external casing so that the lid can be moved between a closing position, in which the lid closes said first opening, and an open position, in which the lid allows access to said first opening from outside of said transducer,
wherein said closure system comprises:
first locking means associated with said lid, which, when said lid is positioned in said closing position, is at least partially accessible from the outside of said transducer so that said first locking means can be moved, selectively, from a first locking position, in which said first locking means prevent the movement of said lid from said closing position to said open position, to a first unlocking position in which said first locking means allow this movement, and vice versa;
second locking means positioned between said lid and said first locking means, which, when said lid is in the closing position and said first locking means are in said first locking position, said second locking means are at least partially accessible from the outside of said transducer, so that said second locking means can be moved, selectively, from a second locking position, in which said second locking means prevent the movement of said first locking means from said first locking position to said first unlocking position, to a second unlocking position, in which said second locking means allow such movement,
wherein, to move said lid from said closing position to said open position, said second locking means must be moved to said second unlocking position, and maintained in said second unlocking position, and subsequently said first locking means must be moved to said first unlocking position.

2. The transducer as in claim 1, wherein said closure system comprises first elastic means configured to exert a first closing force on said first locking means configured to move said first locking means from said first unlocking position to said first locking position, when said first locking means are in said first unlocking position.

3. The transducer as in claim 2, wherein said first elastic means comprise a flat spring.

4. The transducer as in claim 1, wherein said closure system comprises second elastic means configured to exert a second closing force on said second locking means that is configured to move said second locking means from said second unlocking position to said second locking position, when said second locking means are in said second unlocking position.

5. The transducer as in claim 4, wherein said second elastic means comprise a compression spring.

6. The transducer as in claim 1, wherein said first locking means are configured to be moved from said first locking position to said first unlocking position, and vice versa, along a straight first sliding direction.

7. The transducer as in claim 1, wherein said second locking means are configured to be moved from said second locking position to said second unlocking position, and vice versa, along a straight second sliding direction.

8. The transducer as in claim 6, wherein said second locking means are configured to be moved from said second locking position to said second unlocking position, and vice versa, along a straight second sliding rection, and
wherein said first sliding direction and said second sliding direction are perpendicular to each other.

9. The transducer as in claim 1, wherein said lid is rotatably associated with said external casing near said internal housing.

10. The transducer as in claim 1, further comprising an insert configured to house a battery, said internal housing being being configured to house said insert, said insert being associated with said external casing, inside said internal housing, and said lid being rotatably associated with said external casing through said insert.

11. A battery-operated transducer configured to verify a tightening tool by measuring one or more parameters of a joint, comprising:
an external casing comprising an internal housing configured to house a battery and being accessible from a first opening in the external casing;
a closure configured to close the first opening, the closure comprising a lid configured to close the first opening and to be rotatably associated with the external casing so that the lid can be moved between a closing position, in which the lid closes the first opening, and an open position, in which the lid allows access to the first opening from outside of the transducer,
wherein the closure comprises:
a first locking portion associated with the lid, which, when the lid is positioned in the closing position, is at least partially accessible from the outside of the transducer so that the first locking portion can be moved, selectively, from a first locking position, in which the first locking portion is configured to prevent the movement of the lid from the closing position to the open position, to a first unlocking position, in which the first locking portion allows the movement of the lid from the closing position to the open position, and vice versa;
a second locking portion positioned between the lid and the first locking portion, which, when the lid is in the closing position and the first locking portion is in the first locking position, the second locking portion is at least partially accessible from the outside of the transducer, so that the second locking portion can be moved, selectively, from a second locking position, in which the second locking portion prevents the movement of the first locking portion from the first locking position to the first unlocking position, to a second unlocking position, in which the second locking portion allows the movement of the first locking portion from the first locking position to the first unlocking position,
wherein, to move the lid from the closing position to the open position, the second locking portion must be moved to the second unlocking position, and maintained in the second unlocking position, and subsequently the first locking portion must be moved to the first unlocking position.

12. The transducer as in claim 11, wherein the closure comprises a first biasing portion configured to exert a first closing force on the first locking portion that is configured to move the first locking portion from the first unlocking position to the first locking position, when the first locking portion is in the first unlocking position.

13. The transducer as in claim 12, wherein the first biasing portion comprises a flat spring.

14. The transducer as in claim 11, wherein the closure comprises a second biasing portion configured to exert a second closing force on the second locking portion that is configured to move the second locking portion from the second unlocking position to the second locking position, when the second locking portion is in the second unlocking position.

15. The transducer as in claim 14, wherein the second biasing portion comprises a compression spring.

16. The transducer as in claim 11, wherein the first locking portion is configured to be moved from the first locking position to the first unlocking position, and from the first unlocking position to the first locking position, along a straight first sliding direction.

17. The transducer as in claim 11, wherein the second locking portion is configured to be moved from the second locking position to the second unlocking position, and from the second unlocking position to the second locking position, along a straight second sliding direction.

18. The transducer as in claim 16, wherein the second locking portion is configured to be moved from the second locking position to the second unlocking position, and from the second unlocking position to the second locking position, along a straight second sliding direction, and wherein the first sliding direction and the second sliding direction are perpendicular to each other.

19. The transducer as in claim 11, wherein the lid is rotatably associated with the external casing near the internal housing.

20. The transducer as in claim 11, further comprising an insert configured to house a battery, the internal housing being configured to house the insert, the insert being associated with the external casing inside the internal housing, and the lid being rotatably associated with the external casing through the insert.
